(19) United States
(12) Patent Application Publication
(10) Pub. No.: US 2004/0238189 A1
(43) Pub. Date: Dec. 2, 2004

(54) Clamp action shovel with opposing blades, lever actuation and foot pusher platform

(76) Inventors: Jonathan Paul Ruppert, Sacramento, CA (US); Mark Allen Ruppert, Tracy, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/899,828

(22) Filed: Jul. 26, 2004

(51) Int. Cl. A01B 45/00

(52) U.S. Cl. 172/21

(57) ABSTRACT

A shovel apparatus for extracting soil plugs, has a linearly extensive tubular member engaging, a handle at one end and a pair of spaced-apart, opposing, shovel blades at the other. Each of the shovel blades has a blade base with an extensive stem placed approximately vertically. The blades provide a blade tip configured for insertion into a soil medium. Each of the extensive stems is pivotally joined with an actuating link. An actuating rod moves linearly within the tubular member and is joined with the actuating links for providing pivotal motion to The actuating rod is further joined with a lever arm extending laterally from the tubular member. Lever action of the lever arm moves the actuating rod linearly within the tubular member, and thereby moves the actuating links in rotational angular motion, and thereby draws the extensive stems of the shovel blades toward and away from each other for first gripping a plug of the soil medium, and then releasing it.

### BACKGROUND OF THE INVENTION

1. Field of the Invention

This invention relates generally to shovels and more particularly to a shovel with dual opposing blades and a lever action mechanism for drawing the blades together in a clamping action, and a platform for pushing the blades into an earthen surface by foot.

1. Description of the Related Art

Many forms of shovel are known in the art. These include single bladed shovels for moving coal, earth and snow. A coal shovel is formed as a scoop so as to retain coal pieces on its blade while moving from one place to another or throwing the coal. Earth moving shovels take several common forms including the well known rounded front edge shovel for digging holes, also called a spade, and the flat front edged shovel for picking-up loose material from a flat surface. Snow shovels are generally made with a flat front edge as well, and a broad width which seems to work well with frozen materials. Dual opposing blade shovels are known as post diggers and generally incorporate a means for drawing the blades together to hold earth between the blades. A common variety of this type of shovel comprises a pair of spades mounted in opposing positions and hinged for opening and closing the blades.

Hound Dog Products, Inc. of Edina Minn. manufactures an earth coring tool trademarked as Bulb Hound®, comprising a tubular blade that is forced into an earthen surface by stepping on a push bar, and then when the tool is pulled from the earthen surface, the engaged earthen plug captured in the tube is able to be released from the tube by a hand operated push bar.

Costa, U.S. Pat. No. 6,662,879 teaches a combined bulb and vegetable planter which is spring loaded to allow the user to readily remove a plug of soil from the ground, either for the purpose of planting vegetables and disposing of the plug of soil or planting a bulb and returning the plug of soil into the ground and over the planted bulb. In either operation, a plunger or cylinder is pressed into the soil by exerting a force on a foot rest attached to the cylinder or plunger. Extending vertically from the plunger or cylinder is a hollow tubing housing a shaft having a spring disposed about a portion thereof between a spring tension collar and an alien screw for compressing the spring when desired. A gripping handle is provided near the upper end of the vertically extending hollow tubing for the purpose of being gripped by the user of the invention. Extending above this gripping handle is a knob handle with brass plug and alien screw, and further, having a rubber compressions spacer which forms the operating mechanism for the spring.

Mickle et al, U.S. Pat. No. 6,374,758 teaches an apparatus to aid in the planting of pre-grown plants, flowers, and vegetables. It takes the shape of a garden tool with a “T” shaped handle atop a cylindrical pipe with an integral cutting edge approximately 4 inches in diameter. The cutting edge is simply placed on top of the soil where the hole is desired and pushed down while turning. The handle is then withdrawn along with a soil “plug” or cylinder. An ejection lever with associated linkage and plunger mechanisms then pushes the plug out of the invention, thus allowing the invention to quickly dig another hole.

Ruppert et al, U.S. Pat. No. 6,338,512 teaches a shovel apparatus for digging holes and which has an H-shaped frame providing at one end, a handle integrally joined to the frame, and at the other end, a blade mounting support. A pair of spaced apart shovel blades are pivotally engaged with the blade mounting support for drawing the blades from essentially parallel rest positions, toward each other, to form a modified cone-shaped enclosure. A draw arm assembly is engaged for sliding within a pair of opposing slots in the H-shaped frame. The draw arm assembly is engaged with the shovel blades through a pair of links to move the shovel blades toward each other when the draw arm assembly is pulled toward the handle.

The prior art teaches soil plug removers based on the insertion of a tubular blade and removal thereafter. My prior patent, U.S. Pat. No. 6,338,512 teaches opposing shovel blades which are drawn together by drawing a handle assembly in the palm of one hand. Various ways are taught for the release of the soil plug including spring tension release. However, the prior art does not teach an opposing blade digger operable from a standing position with a lever action for drawing the blades together and a step surface for driving the blades into a soil surface using a foot. The present invention fulfills these needs and provides further related advantages as described in the following summary.

### SUMMARY OF THE INVENTION

The present invention teaches certain benefits in construction and use which give rise to the objectives described below.

A shovel apparatus for extracting soil plugs from a standing position, has a linearly extensive tubular structural member engaging, a rigid handle at one end and a pair of spaced-apart, opposing, shovel blades at the other. Each of the shovel blades has a blade base with an extensive stem placed approximately vertically. The blades provide a blade tip configured for insertion into a soil medium. Each of the extensive stems is pivotally joined with an actuating link. An actuating rod moves linearly within the tubular member and is joined with the actuating links for providing pivotal motion to The actuating rod is further joined with a lever arm extending laterally from the tubular member. Lever action of the lever arm moves the actuating rod linearly within the tubular member, and thereby moves the actuating links in rotational angular motion, and thereby draws the extensive stems of the shovel blades toward and away from each other for first gripping a plug of the soil medium, and then releasing it.

A primary objective of the present invention is to provide an apparatus and method of fabricating such apparatus that provides advantages not taught by the prior art.

Another objective is to provide such an invention capable of scooping a portion of soil so as to create a hole for planting a bulb or other plant, or an object.

A further objective is to provide such an invention capable of simple manual manipulation of a pair of opposing shovel blades.

A still further objective is to provide such an invention capable of automatically returning the blades to a spread apart attitude by relieving pressure on a lever arm of the invention.

A yet further objective is to provide such an invention capable of being operated from a standing position while using one's foot to drive shovel blades of the invention into the ground.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is an enlarged and close-up perspective view of a distal end of a preferred embodiment of the present invention shown in its relaxed state;

FIG. 2 is a broken perspective view thereof showing both proximal and distal ends;

FIG. 3 is a perspective view of the full length thereof showing hand and foot accommodations for actuation and use of the invention; and

FIGS. 4-7 are side elevational views thereof defining the primary use of the invention including downward translation and insertion into a soil medium in FIGS. 4 and 5 respectively; closure of opposing shovel elements in FIG. 6 by elevating an operating lever, and extraction of a soil plug by upward translation in FIG. 7.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

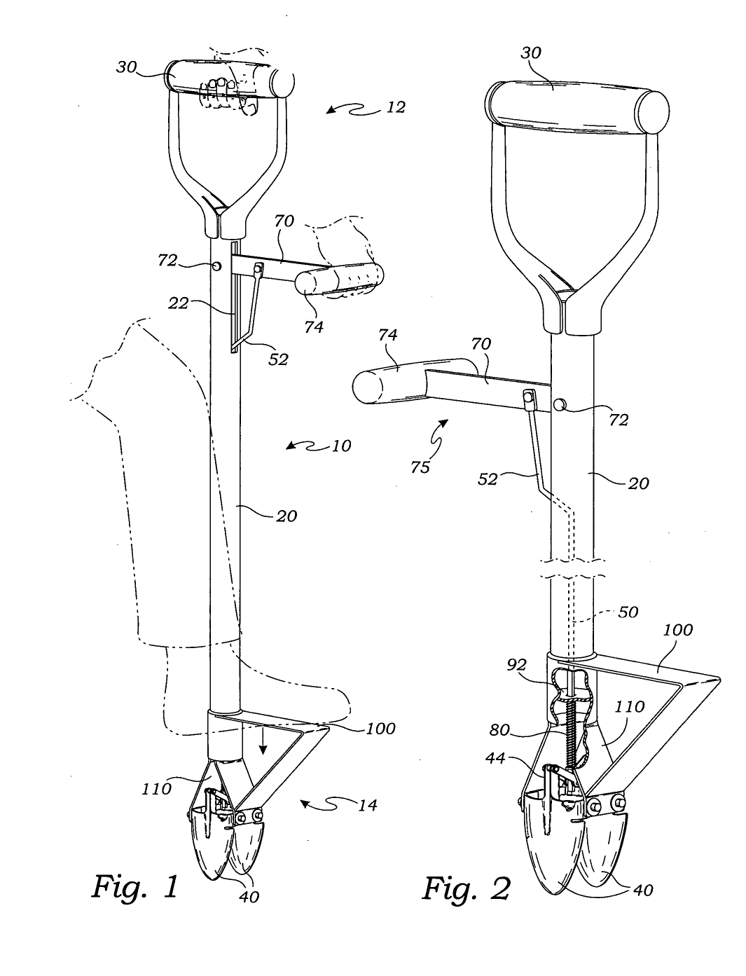

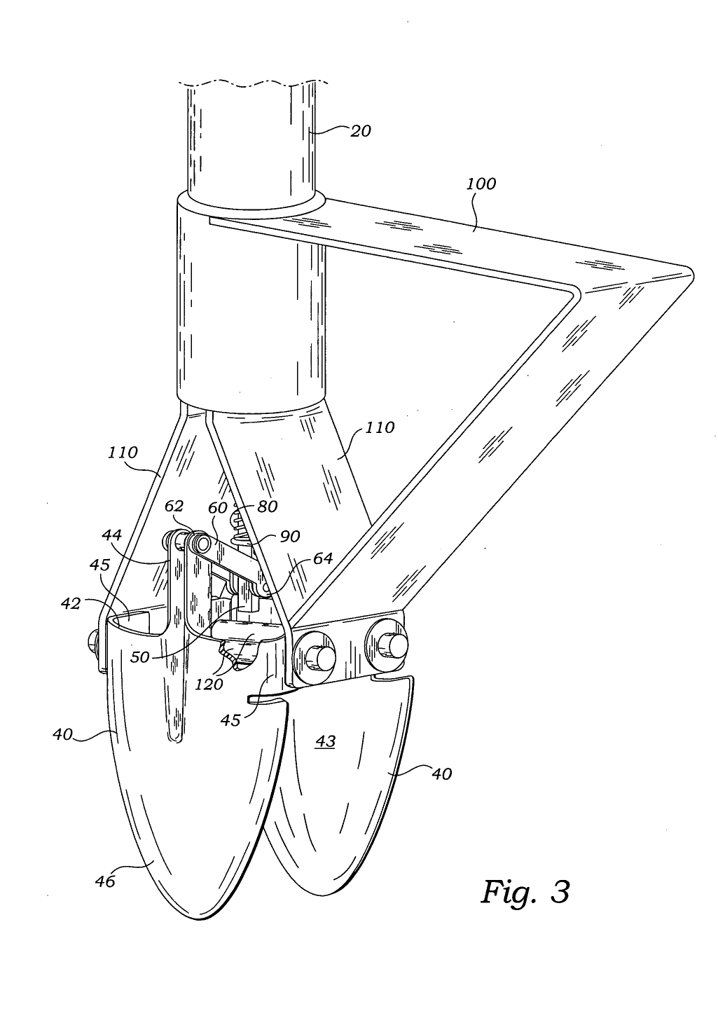

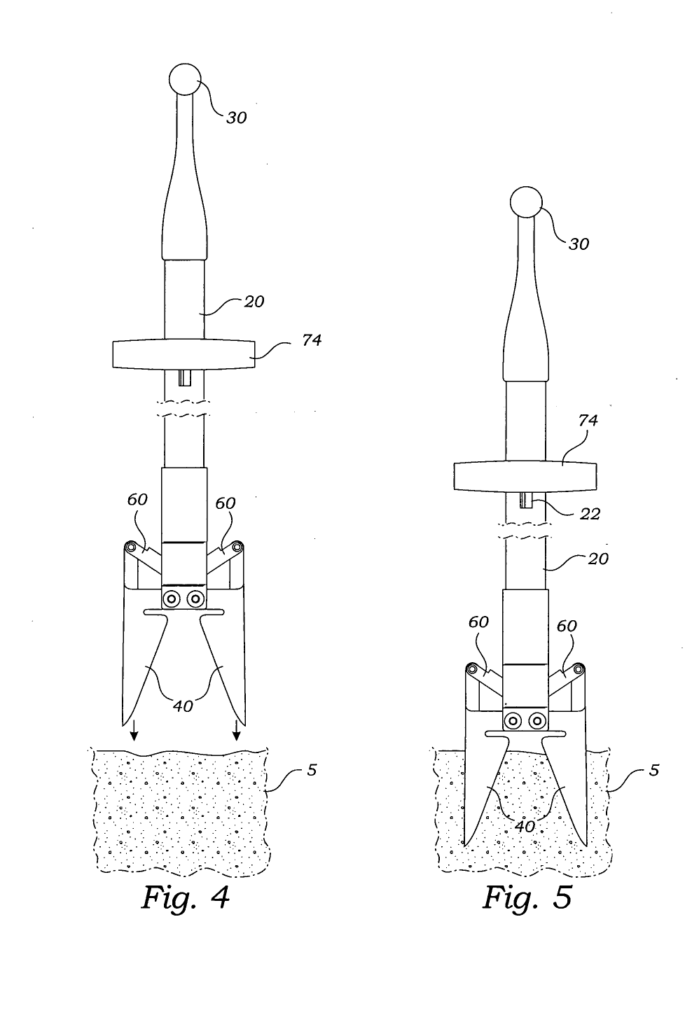

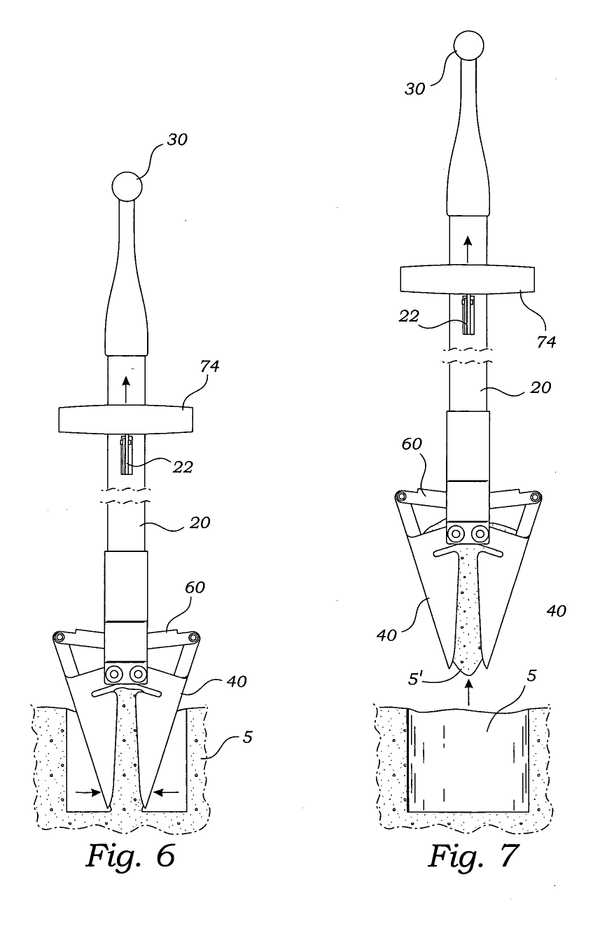

In one embodiment of the present invention shown in FIG. 1, a shovel apparatus useful for extracting soil plugs and other garden uses, comprises an elongate assembly 10 adapted for use in a vertical attitude with an upper proximal end 12 adapted for holding the apparatus, and a lower distal end 14 adapted for insertion of shovel blades of the apparatus into a soil medium 5. The assembly 5 includes a linearly extensive structural tubular member 20 engaging proximally, a handle 30 similar to those used in common shovels, and distally, a pair of spaced-apart, opposing, shovel blades 40. Each of the shovel blades 40 provides, proximally, a blade base 42 having a proximally directed extensive stem 44 integral with the blade 40 and of high strength and low flexture under stress, and distally, a blade tip 46 configured by its spade-like contour for relative ease of insertion into the soil medium 5, by which is meant any base substance normally found in the garden or similar areas including earthen substances, loams, gravels, etc., as shown in FIGS. 4 and 5. Each of the extensive stems 44 is joined pivotally with a first end 62 of one of a pair of actuating links 60 and this is best seen in FIG. 3. A rigid actuating rod 50, preferably of structural steel, is coaxially positioned within the tubular member 20 (FIG. 2) and is distally joined with a second end 64 of each of the actuating links 60 for pivotal motion therewith. The actuating rod 50 is proximally joined with a lever arm 70, again in pivotal engagement. The lever arm 70 preferably extends laterally from the tubular member 20 and is mounted in proximity to the handle 30 so that the user may hold the apparatus in one hand by its handle 30 while operating the lever arm 70 with the other hand as shown in FIG. 1. Lever action, vertically, of the lever arm 70 moves the actuating rod 50 linearly within the tubular member 20, and thereby moves the actuating links 60 in rotational angular motion, which draws the extensive stems 44 of the shovel blades 40 toward and away from each other as the lever arm 70 is pushed down or pulled up, respectively.

A biasing element 80 such as a coil spring, as shown in FIGS. 2 and 3 is preferably positioned coaxially about the actuating rod 50 and is engaged for urging the actuating rod 50 in distal translation. With the lever arm 70 pushed into its most downward attitude (FIGS. 4 and 5), the coil spring is only slightly compressed so that the shovel blades 40 remain in an open attitude. With the lever arm 70 is pulled into its most upward attitude (FIGS. 6 and 7), the coil spring is greatly compressed so that the lever arm 50 must be manually held in the upward attitude until ready to expel the soil plug 5′ from between the blades 40 (FIG. 7). Upon release of the lever arm 70, the coil spring 80 extends pushing the actuating rod 50 distally, which opens the shovel blades 40. To accomplish this, the coil spring 80 is captured between a distal washer 90 fixed to, and moving with, the lower end of the actuating rod 50 (FIG. 3), and a proximal washer 92 fixed immovably within the tubular member 20 (FIG. 2).

The apparatus preferably includes a distally positioned foot receiving surface 100 for pressing the shovel blades 40 into the soil medium 5. Such a surface 100 may be provided by a V-shaped plate welded to the assembly as shown in FIGS. 1-3, or by other means known in the art. Surface 100 is placed so as to be convenient to placement of a foot thereon for applying downward pressure as seen in FIG. 1, while the user is standing.

Preferably, the lever arm 70 is pivotally joined with the tubular member 20 at bolt 72 so as to be able to rotate about bolt 72 in a vertical direction. To accomplish this rotation, a handle bar 74 is mounted terminally to the lever arm 70 as best illustrated in FIG. 1.

Preferably, the actuating rod 50 provides a dog-leg distal portion 52 extensive laterally through a slot 22 in the tubular member 20; the actuating rod 50 pivotally joined at a medial position 75 on the lever arm 70 for leverage in moving the actuating rod 50.

Preferably, each of the shovel blades 40 is formed from steel sheet metal stock into a concave blade surface 43, a pair of laterally opposing ears 45 contiguous with the blade base 42, and the extensive stem 44 formed into a U-shaped structure for rigidity. This construction has the advantage of fabricating the shovel blades 40 at low cost but with high strength and durability.

The pair of laterally opposing ears 45 of each of the shovel blades 40 are preferably rotationally engaged with a shovel support housing 110 as shown best in FIG. 3, and one of a pair of support spacers 120 which functions to maintain the support housing 110 in its preferred orientation and to act as pivotal axels for rotation of the shovel blades 40.

The present invention is preferably formed using a method of constructing comprising the steps of adapting an elongate assembly for use in a vertical attitude by defining an upper proximal end and a lower distal end; making-up the assembly by forming the linearly extensive tubular member 20; engaging the tubular member 20 proximally with, the handle 30; and distally, with the pair of spaced-apart, opposing, shovel blades 40, each having, proximally, a blade base 42 with a proximally directed extensive stem 44, and a distally directed blade tip 46 configured for insertion into the soil medium 5; and joining each of the extensive stems 44 pivotally with the first end 62 of one of the pair of actuating links 60 while positioning the actuating rod 50 coaxially within the tubular member 20 and distally joining it with a second end 64 of each of the actuating links 60 for pivotal motion therewith; joining the actuating rod 50 proximally with the lever arm 70 for pivotal motion therewith, the lever arm 70 extending laterally from the tubular member 20 in proximity with the handle 30; wherein, lever action of the lever arm 70 moves the actuating rod 50 linearly within the tubular member 20, thereby moving the actuating links 60 in rotational angular motion, and further drawing the extensive stems 44 of the shovel blades 40 toward and away from each other for gripping and releasing the soil medium 5.

The present invention also encompasses a method of removing the soil plug 5′ from the soil medium 5 comprising the steps of: setting the pair of shovel blades 40 on a surface of the soil medium 5 from a standing position; pressing a foot against the foot receiving surface 100 positioned above and to one side of the blades 40 so as to drive the shovel blades 40 into the soil medium 5; lifting the lever 75 to rotate the shovel blades 40 toward each other at tips 46 of the shovel blades 40 so as to capture the plug 5′ of the soil medium 5; and removing the shovel blades 40 from the soil medium 5 to extract the plug 5′ from the soil medium 5. Such method may also include lowering the lever 75 so as to release the soil plug 5′.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention

What is claimed is:

1. A shovel apparatus for extracting soil plugs, the apparatus comprising: an elongate assembly adapted for use in a vertical attitude with an upper proximal end and a lower distal end; the assembly including a linearly extensive tubular member engaging proximally, a handle; and distally, a pair of spaced-apart, opposing, shovel blades; each of the shovel blades providing, proximally, a blade base having a proximally directed extensive stem, and distally, a blade tip configured for insertion into a soil medium; each of the extensive stems joined pivotally at a first end of one of a pair of actuating links; an actuating rod coaxially positioned within the tubular member and distally joined with a second end of each of the actuating links for pivotal motion therewith; the actuating rod proximally joined with a lever arm for pivotal motion therewith, the lever arm extending laterally from the tubular member in proximity with the handle; wherein, lever action of the lever arm moves the actuating rod linearly within the tubular member, and thereby moves the actuating links in rotational angular motion, and thereby draws the extensive stems of the shovel blades toward and away from each other.

2. The apparatus of claim 1 further comprising a bias means positioned coaxially about the actuating rod and engaged for urging the actuating rod in distal translation.

3. The apparatus of claim 1 further comprising a distally positioned foot receiving surface for pressing the shovel blades into the soil medium.

4. The apparatus of claim 1 wherein the lever arm is pivotally joined with the tubular member.

5. The apparatus of claim 4 wherein the actuating rod provides a dog-leg distal portion extensive laterally through a slot in the tubular member; the actuating rod pivotally joined at a medial position on the lever arm.

6. The apparatus of claim 1 wherein each of the shovel blades is formed from sheet metal stock into a concave blade surface, a pair of laterally opposing ears contiguous with the blade base, and a U-shaped said extensive stem.

7. The apparatus of claim 6 wherein the pair of laterally opposing ears of each of the shovel blades are rotatingly engaged with a shovel support housing and one of a pair of support spacers.

8. A method of constructing a shovel apparatus useful for extracting soil plugs, the method comprising the steps of: adapting an elongate assembly for use in a vertical attitude defining an upper proximal end and a lower distal end; making-up the assembly by forming a linearly extensive tubular member; engaging the tubular member proximally with, a handle; and distally, with a pair of spaced-apart, opposing, shovel blades, each having, proximally, a blade base with a proximally directed extensive stem, and a distally directed blade tip configured for insertion into a soil medium; joining each of the extensive stems pivotally with a first end of one of a pair of actuating links; positioning an actuating rod coaxially within the tubular member and distally joining it with a second end of each of the actuating links for pivotal motion therewith; joining the actuating rod proximally with a lever arm for pivotal motion therewith, the lever arm extending laterally from the tubular member in proximity with the handle; wherein, lever action of the lever arm moves the actuating rod linearly within the tubular member, and thereby moves the actuating links in rotational angular motion, and thereby draws the extensive stems of the shovel blades toward and away from each other for gripping the soil medium.

9. A method of removing a soil plug from a soil medium comprising the steps of: setting a pair of shovel blades on a surface of a soil medium from a standing position; pressing a foot against a foot receiving surface positioned above and to one side of the blades so as to drive the shovel blades into the soil medium; lifting a lever to rotate the shovel blades toward each other at tips of the shovel blades so as to capture a plug of the soil medium; and removing the shovel blades from the soil medium to extract the plug from the soil medium.
